(19) United States
(12) Patent Application Publication
(10) Pub. No.: US 2024/0269607 A1
(43) Pub. Date: Aug. 15, 2024

(54) CARBON DIOXIDE RECOVERY METHOD AND CARBON DIOXIDE RECOVERY SYSTEM USING CARBON DIOXIDE CYCLE POWER GENERATION UNIT

(71) Applicant: JGC CORPORATION, Kanagawa (JP)

(72) Inventors: Yuzuru KAKUTANI, Kanagawa (JP); Hiroyuki ISOBE, Kanagawa (JP)

(73) Assignee: JGC CORPORATION, Kanagawa (JP)

(21) Appl. No.: 18/681,076

(22) PCT Filed: Aug. 6, 2021
(86) PCT No.: PCT/JP2021/029266

§ 371 Date: Feb. 5, 2024

(51) Int. Cl. B01D 53/14; B01D 53/34; B01D 53/62; B01D 53/78; B01D 53/96; C01B 32/50; F02C 3/34

(52) U.S. Cl. CPC B01D 53/1475; B01D 53/1418; B01D 53/1425; B01D 53/343; B01D 53/62; B01D 53/78; B01D 53/96; C01B 32/50; F02C 3/34; B01D 2252/204; B01D 2257/504; B01D 2258/0283

(57) ABSTRACT

A CO₂ cycle power generation unit including a power generation turbine using a CO₂ fluid as a drive fluid, a CO₂ first compression device pressurizing the CO₂ fluid after driving the power generation turbine, and a combustor combusting a light hydrocarbon gas containing methane as fuel using oxygen supplied from an air separation device in a state of mixing the pressurized and heated CO₂ fluids, wherein a combustion gas obtained by the combustor is supplied to the power generation turbine as a drive fluid, and a CO₂ recovery unit recovering CO₂ from an exhaust gas emitted by fuel combustion in an external combustion unit. A part of the CO₂ fluid emitted from the CO₂ cycle power generation unit and CO₂ recovered by the CO₂ recovery unit are supplied to a CO₂ reception unit. Energy obtained by the CO₂ cycle power generation unit is supplied to the CO₂ recovery unit.

### TECHNICAL FIELD

The present invention relates to a carbon dioxide recovery method and a carbon dioxide recovery system.

### BACKGROUND ART

Patent Literature 1 describes that carbon dioxide recovered by a carbon dioxide absorption tower is brought into a supercritical state, and the supercritical carbon dioxide is sent to a coal-fired power plant to be used as a power generation working fluid.

Patent Literature 2 describes that carbon dioxide in an exhaust gas of a ship engine is collected, and changed into a supercritical fluid, and electric power generated by the supercritical fluid is used for ship electric power.

### CITATION LIST

### Patent Literature

Patent Literature 1: Chinese Patent Application Publication No 107626185.
Patent Literature 2: Korean Patent Publication No. 10-2017-0041531

### SUMMARY OF INVENTION

### Technical Problem

Conventionally, an exhaust gas from a boiler, a heating furnace, or a gas turbine or the like installed in an oil plant, a gas plant, a chemical plant, a power plant, or a steel mill or the like (hereinafter, a plant or the like) is released into the atmosphere after satisfying environmental standards via an exhaust heat recovery, desulfurization, or denitration process. At this time, carbon dioxide (CO₂) in the exhaust gas is released into the atmosphere as it is.

In the case of recovering CO₂ in the exhaust gas, for example, an acid gas removal unit (AGRU) using an amine absorption process or the like is used. It has been proposed that the recovered CO₂ is stored in a carbon dioxide capture and storage (CCS) in an aquifer or the like in the ground.

Conventionally, about 90% of CO₂ in the exhaust gas can be recovered, whereby the emission amount of CO₂ is apparently suppressed. Meanwhile, in order to recover CO₂ by CCS, it is necessary to pressurize CO₂ to a predetermined pressure (200 to 300 bar). A compressor used to pressurize CO₂ is driven with electric power. When the compressor is driven using electric power derived from carbon-containing fuel, CO₂ is emitted during power generation.

When CO₂ is recovered by AGRU, for example, a CO₂ absorbent such as amine is used to absorb CO₂, and the CO₂ absorbent is heated to release CO₂, thereby regenerating the CO₂ absorbent. A heating source such as water vapor is used for heating the CO₂ absorbent, but when fuel containing a hydrocarbon is used for generating the heating source, CO₂ is emitted.

It is also conceivable to supply electric power for driving the compressor from renewable energy power generation such as solar power generation, wind power generation, solar thermal power generation, or geothermal power generation, or use the above-described renewable energy source as a heating source for regenerating the CO₂ absorbent. However, the use of renewable energy has great constraints such as geographical conditions, and makes it difficult to stably supply electric power.

As described above, when CO₂ in an exhaust gas of a plant or the like is recovered, and stored in CCS, the amount of CO₂ apparently released into the atmosphere can be greatly reduced, but in the present situation, a certain amount of CO₂ is emitted in order to recover CO₂ in the entire of units required for recovering CO₂. However, if AGRUs are individually installed in the units with CO₂ emission to suppress the release of CO₂ into the atmosphere, the cost of the entire of the units increases.

The present invention has been made in view of the above circumstances, and an object thereof is to provide a carbon dioxide recovery method and a carbon dioxide recovery system using a carbon dioxide cycle power generation unit capable of suppressing the emission of CO₂ into the atmosphere when recovering CO₂.

### Solution to Problem

A first aspect of the present invention is a carbon dioxide recovery method using a carbon dioxide recovery system, the carbon dioxide recovery system including: a carbon dioxide cycle power generation unit including a power generation turbine using a carbon dioxide fluid as a drive fluid, a CO₂ first compression device pressurizing the carbon dioxide fluid after driving the power generation turbine, a CO₂ heat exchanger heating the carbon dioxide fluid pressurized by the CO₂ first compression device, and a combustor mixing the carbon dioxide fluid heated by the CO₂ heat exchanger, oxygen supplied from an air separation device, and a light hydrocarbon gas containing methane as a main component, to combust the light hydrocarbon gas under heating, wherein a combustion gas obtained by heating in the combustor is supplied to the power generation turbine as the drive fluid; and a carbon dioxide recovery unit recovering carbon dioxide from a carbon dioxide-containing exhaust gas emitted by fuel combustion in an external combustion unit, wherein: a part of the carbon dioxide fluid emitted from the carbon dioxide cycle power generation unit and the carbon dioxide recovered by the carbon dioxide recovery unit are supplied to a carbon dioxide reception unit capable of receiving carbon dioxide; and energy obtained by the carbon dioxide cycle power generation unit is supplied to the carbon dioxide recovery unit.

A second aspect of the present invention is the carbon dioxide recovery method according to the first aspect, wherein the energy supplied from the carbon dioxide cycle power generation unit to the carbon dioxide recovery unit includes electric power obtained by the power generation turbine.

A third aspect of the present invention is the carbon dioxide recovery method according to the first or second aspect, wherein the energy supplied from the carbon dioxide cycle power generation unit to the carbon dioxide recovery unit includes heat of the carbon dioxide fluid.

A fourth aspect of the present invention is the carbon dioxide recovery method according to any one of the first to third aspects, wherein the energy supplied from the carbon dioxide cycle power generation unit to the carbon dioxide recovery unit includes mechanical power obtained from the combustion gas obtained by the combustor.

A fifth aspect of the present invention is the carbon dioxide recovery method according to the second aspect, wherein: the carbon dioxide recovery unit includes a first acid gas removal unit recovering the carbon dioxide contained in the exhaust gas from the external combustion unit, and a first acid gas pressurizing unit pressurizing the carbon dioxide recovered by the first acid gas removal unit; and the electric power obtained by the power generation turbine is supplied to the first acid gas pressurizing unit.

A sixth aspect of the present invention is the carbon dioxide recovery method according to the third aspect, wherein: the carbon dioxide recovery unit includes a first acid gas removal unit recovering the carbon dioxide contained in the exhaust gas from the external combustion unit, and a first acid gas pressurizing unit pressurizing the carbon dioxide recovered by the first acid gas removal unit; and the heat of the carbon dioxide fluid is supplied to the first acid gas removal unit by heat exchange.

A seventh aspect of the present invention is the carbon dioxide recovery method according to the sixth aspect, wherein: the energy supplied from the carbon dioxide cycle power generation unit to the carbon dioxide recovery unit includes the electric power obtained by the power generation turbine and the heat of the carbon dioxide fluid; and the electric power obtained by the power generation turbine is supplied to the first acid gas pressurizing unit.

An eighth aspect of the present invention is the carbon dioxide recovery method according to the sixth or seventh aspect, wherein: the first acid gas removal unit performs a recovery step of causing a carbon dioxide absorbent to absorb the carbon dioxide contained in the exhaust gas from the external combustion unit to recover the carbon dioxide, and a regeneration step of heating the carbon dioxide absorbent to release the carbon dioxide; and the heat of the carbon dioxide fluid is supplied to the regeneration step by heat exchange.

A ninth aspect of the present invention is the carbon dioxide recovery method according to any one of the fifth to eighth aspects, wherein the carbon dioxide pressurized by the first acid gas pressurizing unit is supplied between the power generation turbine and the CO₂ first compression device, and mixed with the carbon dioxide fluid.

A tenth aspect of the present invention is the carbon dioxide recovery method according to any one of the first to ninth aspects, wherein: the carbon dioxide recovery unit includes a first acid gas removal unit recovering the carbon dioxide contained in the exhaust gas from the external combustion unit, and a first acid gas pressurizing unit pressurizing the carbon dioxide recovered by the first acid gas removal unit; and the first acid gas pressurizing unit pressurizes a carbon dioxide-containing gas recovered from the exhaust gas from the external combustion unit by the first acid gas removal unit and a carbon dioxide-containing gas recovered from a second acid gas removal unit which is an acid gas removal unit other than the first acid gas removal unit.

A 11th aspect of the present invention is the carbon dioxide recovery method according to any one of the first to tenth aspects, wherein the heat of the exhaust gas from the external combustion unit is supplied to the carbon dioxide fluid circulating in the carbon dioxide cycle power generation unit and having a temperature lower than that of the exhaust gas by heat exchange.

A 12th aspect of the present invention is the carbon dioxide recovery method according to any one of the first to 11th aspects, wherein: the external combustion unit includes a combustion furnace; the carbon dioxide recovery system includes an air separation device separating oxygen supplied to the carbon dioxide cycle power generation unit from air; and a part of the oxygen obtained by the air separation device is supplied to the combustion furnace.

A 13th aspect of the present invention is the carbon dioxide recovery method according to any one of the first to 12th aspects, wherein the heat of the carbon dioxide fluid is supplied from the carbon dioxide cycle power generation unit to an outside of the carbon dioxide cycle power generation unit.

A 14th aspect of the present invention is a carbon dioxide recovery system including: a carbon dioxide cycle power generation unit including a power generation turbine using a carbon dioxide fluid as a drive fluid, a CO₂ first compression device pressurizing the carbon dioxide fluid after driving the power generation turbine, a CO₂ heat exchanger heating the carbon dioxide fluid pressurized by the CO₂ first compression device, and a combustor mixing the carbon dioxide fluid heated by the CO₂ heat exchanger, oxygen supplied from an air separation device, and a light hydrocarbon gas containing methane as a main component, to combust the light hydrocarbon gas under heating, wherein a combustion gas obtained by heating in the combustor is supplied to the power generation turbine as the drive fluid; and a carbon dioxide recovery unit recovering carbon dioxide from a carbon dioxide-containing exhaust gas emitted by fuel combustion in an external combustion unit, wherein: a part of the carbon dioxide fluid emitted from the carbon dioxide cycle power generation unit and the carbon dioxide recovered by the carbon dioxide recovery unit are supplied to a carbon dioxide reception unit capable of receiving carbon dioxide; and energy obtained by the carbon dioxide cycle power generation unit is supplied to the carbon dioxide recovery unit.

A 15th aspect of the present invention is the carbon dioxide recovery system according to the 14th aspect, wherein the energy supplied from the carbon dioxide cycle power generation unit to the carbon dioxide recovery unit includes at least one energy form selected from electric power obtained by the power generation turbine, heat of the carbon dioxide fluid, and mechanical power obtained from the combustion gas obtained by the combustor.

### Advantageous Effects of Invention

According to the first aspect, the use of the carbon dioxide cycle power generation unit as the energy source of the carbon dioxide recovery unit makes it possible to suppress the emission of CO₂ into the atmosphere and reduce the cost.

According to the second aspect, the electric power is supplied from the carbon dioxide cycle power generation unit as a power source for the carbon dioxide recovery unit, which makes it possible to suppress the emission of CO₂ into the atmosphere and reduce the cost.

According to the third aspect, the use of the heat from the carbon dioxide cycle power generation unit as a heating source required for the carbon dioxide recovery unit makes it possible to suppress the emission of CO₂ into the atmosphere and reduce the cost.

According to the fourth aspect, the use of the energy generated in the carbon dioxide cycle power generation unit as the mechanical power source of the carbon dioxide recovery unit makes it possible to suppress the emission of CO₂ into the atmosphere and reduce the cost.

According to the fifth aspect, when the carbon dioxide contained in the exhaust gas from the external combustion unit is recovered by the first acid gas removal unit, and the carbon dioxide recovered by the first acid gas removal unit is pressurized by the first acid gas pressurizing unit, the electric power is supplied from the carbon dioxide cycle power generation unit as the power source of the first acid gas pressurizing unit, whereby the emission of CO₂ into the atmosphere can be suppressed, and the cost can be reduced.

According to the sixth aspect, when the carbon dioxide contained in the exhaust gas from the external combustion unit is recovered by the first acid gas removal unit, and the carbon dioxide recovered by the first acid gas removal unit is pressurized or dehydrated by the first acid gas pressurizing unit, the use of the heat from the carbon dioxide cycle power generation unit as the heating source required for the first acid gas removal unit makes it possible to suppress the emission of CO₂ into the atmosphere and reduce the cost.

According to the seventh aspect, the heat from the carbon dioxide cycle power generation unit is used as the heating source required for the first acid gas removal unit, and the electric power is supplied from the carbon dioxide cycle power generation unit as the power source of the first acid gas pressurizing unit, whereby the emission of CO₂ into the atmosphere can be suppressed, and the cost can be reduced.

According to the eighth aspect, the first acid gas removal unit uses the heat from the carbon dioxide cycle power generation unit as the heating source required for the regeneration step of heating the carbon dioxide absorbent and releasing the carbon dioxide, whereby the emission of CO₂ into the atmosphere can be suppressed and the cost can be reduced.

According to the ninth aspect, it is sufficient that the performance of the first acid gas pressurizing unit used in the carbon dioxide recovery unit can pressurize the carbon dioxide to the same degree as that of the carbon dioxide fluid before being pressurized by the CO₂ first compression device of the carbon dioxide cycle power generation unit, so that the cost required for pressurizing the carbon dioxide can be reduced.

According to the tenth aspect, in the first acid gas removal unit, the CO₂ absorbent can be regenerated using the heat supplied from the carbon dioxide cycle power generation unit. Furthermore, not only the carbon dioxide recovered from the first acid gas removal unit but also the carbon dioxide recovered from the second acid gas removal unit is treated by the first acid gas pressurizing unit, whereby the cost required for pressurizing the carbon dioxide can be further reduced.

According to the 11th aspect, the heat of the exhaust gas from the external combustion unit is used to heat the carbon dioxide fluid having a temperature lower than that of the exhaust gas in the carbon dioxide cycle power generation unit, whereby the power generation efficiency of the carbon dioxide cycle power generation unit can be improved.

According to the 12th aspect, the use of the air separation device attached to the carbon dioxide cycle power generation unit makes it possible to improve the combustion efficiency of the combustion furnace of the external combustion unit, and the exhaust gas of the combustion furnace is composed of high-concentration carbon dioxide, whereby the carbon dioxide can be easily recovered.

According to the 13th aspect, the use of the heat of the carbon dioxide cycle power generation unit as the heating source to the carbon dioxide recovery unit or the external unit makes it possible to suppress the emission of CO₂ generated at the time of acquiring the heat required in the external unit into the atmosphere and reduce the cost.

According to the 14th aspect, the use of the carbon dioxide cycle power generation unit as the energy source of the carbon dioxide recovery unit makes it possible to suppress the emission of CO₂ into the atmosphere and reduce the cost.

According to the 15th aspect, the supply of the electric power from the carbon dioxide cycle power generation unit as the power source for the carbon dioxide recovery unit, and the use of the heat from the carbon dioxide cycle power generation unit as the heating source required for the carbon dioxide recovery unit or the use of the energy generated in the carbon dioxide cycle power generation unit as the mechanical power source for the carbon dioxide recovery unit make it possible to suppress the emission of CO₂ into the atmosphere and reduce the cost.

### BRIEF DESCRIPTION OF DRAWINGS

FIG. 1 is a schematic view showing the outline of a carbon dioxide recovery system.

FIG. 2 is a schematic view showing a carbon dioxide recovery system of a first embodiment.

FIG. 3 is a partially omitted view showing a usage example of electric power and mechanical power.

FIG. 4 is a schematic view showing a carbon dioxide recovery system of a second embodiment.

FIG. 5 is a schematic view showing a carbon dioxide recovery system of a third embodiment.

FIG. 6 is a partially omitted view showing a first modification of a heat transport unit.

FIG. 7 is a partially omitted view showing a second modification of a heat transport unit.

FIG. 8 is a schematic view showing a carbon dioxide recovery system of a fourth embodiment.

### DESCRIPTION OF EMBODIMENTS

Hereinafter, the present invention will be described based on preferred embodiments.

In the description of the embodiments, “carbon dioxide”, “carbon dioxide fluid”, “carbon dioxide cycle power generation unit”, “carbon dioxide recovery unit”, “carbon dioxide reception unit”, “carbon dioxide recovery method”, and “carbon dioxide recovery system” are respectively referred to as “CO₂”, “CO₂ fluid”, “CO₂ cycle power generation unit”, “CO₂ recovery unit”, “CO₂ reception unit”, “CO₂ recovery method”, and “CO₂ recovery system”.

In the description of the embodiments, the “CO₂ fluid” means CO₂ circulating in the CO₂ cycle power generation unit without distinguishing the states of supercritical CO₂, liquefied CO₂, and CO₂ gas and the like. CO₂ recovered from an exhaust gas of an external combustion unit is referred to as “exhaust gas-derived CO₂” without distinguishing the states of CO₂. CO₂ recovered from an existing acid gas removal unit is referred to as “existing AGRU-derived CO₂” without distinguishing the states of CO₂.

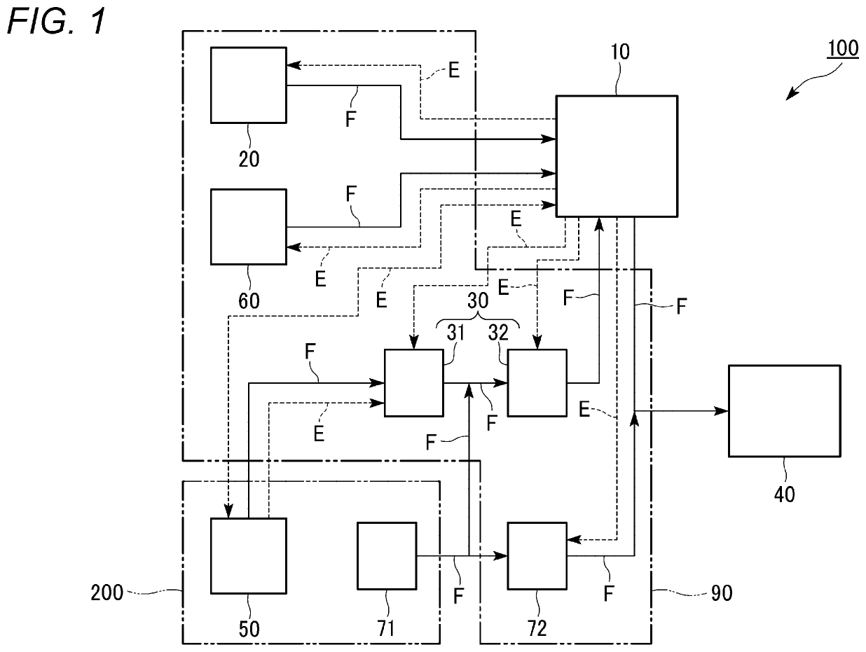

FIG. 1 shows the outline of a CO₂ recovery system 100. The CO₂ recovery system 100 includes, as main components, a supercritical CO₂ cycle power generation unit 10, and a CO₂ recovery unit 90 that recovers CO₂ contained in an exhaust gas of an external combustion unit 50. The supercritical CO₂ cycle power generation unit 10 is an example of the CO₂ cycle power generation unit, and is a unit that generates power using supercritical CO₂ as a drive fluid. The supercritical CO₂ cycle power generation unit 10 and the CO₂ recovery unit 90 are units newly installed to recover an exhaust gas from an external unit 200 when the external unit 200 described later is already installed.

The CO₂ recovery unit 90 includes an air separation device 20, a CO₂ recovery device 30 in which a first acid gas removal unit 31 is newly installed, and a fuel gas supply unit 60. The air separation device 20 preferably includes an oxygen pressurizing device (not shown) that pressurizes oxygen separated from air. The fuel gas supply unit 60 is a unit for supplying a light hydrocarbon gas containing methane as a main component. The CO₂ recovery device 30 may include a first acid gas pressurizing device 32. Furthermore, the CO₂ recovery unit 90 may include a second acid gas pressurizing unit 72 added to a second acid gas removal unit 71 which is the existing acid gas removal unit.

The CO₂ recovery unit 90 may be all units and devices other than the supercritical CO₂ cycle power generation unit 10 among all the units and devices included in the CO₂ recovery system 100. The CO₂ recovery unit 90 can include the air separation device 20, the CO₂ recovery device 30, the first acid gas removal unit 31, the first acid gas pressurizing device 32, the fuel gas supply unit 60, and the second acid gas pressurizing unit 72 and the like. The second acid gas removal unit 71 and the external combustion unit 50 may be the external unit 200.

The CO₂ recovery system 100 can supply energy obtained by the supercritical CO₂ cycle power generation unit 10 to at least any one selected from the air separation device 20, the CO₂ recovery device 30, the fuel gas supply unit 60, and the second acid gas pressurizing unit 72. The CO₂ recovery system 100 may supply the energy obtained by the supercritical CO₂ cycle power generation unit 10 to the entire CO₂ recovery unit 90. In particular, at least one energy form selected from electric power, heat, and mechanical power required in the air separation device 20, the CO₂ recovery device 30, the fuel gas supply unit 60, and the second acid gas pressurizing unit 72 and the like may be supplied from the supercritical CO₂ cycle power generation unit 10.

Oxygen and a fuel gas are supplied as a fluid F from the air separation device 20 and the fuel gas supply unit 60 to the supercritical CO₂ cycle power generation unit 10. At the same time, energy E is supplied from the supercritical CO₂ cycle power generation unit 10 to the air separation device 20 and the fuel gas supply unit 60. The energy E is bidirectionally supplied between the external combustion unit 50 and the supercritical CO₂ cycle power generation unit 10.

The energy E and an exhaust gas as the fluid F are supplied from the external combustion unit 50 to the first acid gas removal unit 31. Exhaust gas-derived CO₂ is supplied as the fluid F from the first acid gas removal unit 31 to the supercritical CO₂ cycle power generation unit 10 via the first acid gas pressurizing device 32. The energy E is supplied from the supercritical CO₂ cycle power generation unit 10 to at least one of the first acid gas removal unit 31 and the first acid gas pressurizing device 32. A part of the CO₂ fluid is emitted as the fluid F from the supercritical CO₂ cycle power generation unit 10 to a CO₂ reception unit 40.

From the second acid gas removal unit 71, the existing AGRU-derived CO₂ is emitted as the fluid F to the CO₂ reception unit 40 via the second acid gas pressurizing unit 72. The energy E is supplied from the supercritical CO₂ cycle power generation unit 10 to the second acid gas pressurizing unit 72. The existing AGRU-derived CO₂ may be supplied as the fluid F from the second acid gas removal unit 71 to the supercritical CO₂ cycle power generation unit 10 via the first acid gas pressurizing device 32.

The CO₂ recovery method using the CO₂ recovery system 100 includes a step of supplying a part of the CO₂ fluid emitted from the supercritical CO₂ cycle power generation unit 10 and CO₂ recovered by the CO₂ recovery unit 90 to a CO₂ reception unit 40 and a step of supplying energy obtained by the supercritical CO₂ cycle power generation unit 10 to the CO₂ recovery unit 90. CO₂ recovery systems 101, 102, 103, and 104 of first to fourth embodiments will be shown in detail, and more specifically described.

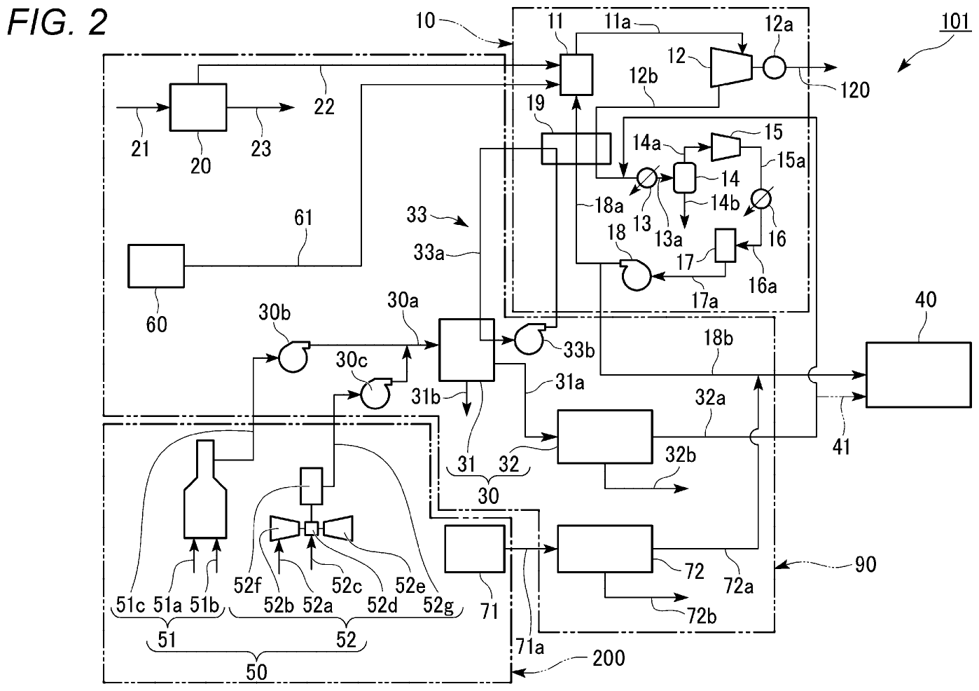

FIG. 2 shows the CO₂ recovery system 101 of the first embodiment. The CO₂ recovery system 101 includes, as main components, a supercritical CO₂ cycle power generation unit 10, and a CO₂ recovery unit 90 that recovers CO₂ contained in an exhaust gas of an external combustion unit 50.

The external combustion unit 50 is not particularly limited as long as it is a combustion unit other than a combustion unit (that is, a supercritical CO₂ generation combustor 11 to be described later) included in the supercritical CO₂ cycle power generation unit 10, and examples thereof include a combustion furnace 51 and a gas turbine device 52. The external combustion unit 50 may be part of an external unit 200 that is not included in the CO₂ recovery system 101. The external unit 200 may be an existing unit that exists before the CO₂ recovery system 101 is constructed. At least a part of the external unit 200 may be newly or additionally installed after the CO₂ recovery system 101 is constructed. The external combustion unit 50 emits a CO₂-containing exhaust gas during combustion of carbon-containing fuel.

The fuel used in the external combustion unit 50 is not particularly limited, and examples thereof include carbonaceous fuels such as coal and charcoal, hydrocarbon-containing fuels such as oil and natural gas, carbon compounds such as carbon monoxide, biomass, and combustible waste. The external combustion unit 50 may mix the two or more kinds of fuels described above and simultaneously combust the mixture, or may select and combust different fuels at different times.

The external combustion unit 50 may be a unit operated by the same company as that of the supercritical CO₂ cycle power generation unit 10 and the CO₂ recovery unit 90, or may be a unit operated by another company. The installation location of the external combustion unit 50 is not particularly limited, and may be in the same site as that of the supercritical CO₂ cycle power generation unit 10 or the CO₂ recovery unit 90, may be adjacent thereto, or may be distant therefrom.

The combustion furnace 51 mixes air supplied from an air path 51a and fuel supplied from a fuel path 51b to combust the fuel. The exhaust gas of the combustion furnace 51 is emitted from an exhaust gas path 51c.

The gas turbine device 52 includes a compressor 52b that compresses air supplied from an air path 52a, a combustor 52d that mixes the compressed air obtained by the compressor 52b and fuel supplied from a fuel path 52c to combust the fuel, and a turbine 52e that converts a high-temperature combustion gas generated in the combustor 52d into power. The application of the power of the turbine 52e is not particularly limited, and the turbine 52e may be used for power generation, and driving of machines and the like. The exhaust gas of the combustor 52d is emitted from an exhaust gas path 52g via an exhaust tube 52f.

The CO₂ recovery unit 90 recovers the exhaust gas of the external combustion unit 50 from the exhaust gas paths 51c and 52g of the external combustion unit 50 via an exhaust gas recovery path 30a. In the exhaust gas recovery path 30a, transfer devices such as exhaust gas blowers 30b and 30c may be disposed in order to facilitate the transfer of the exhaust gas.

The CO₂ recovery unit 90 includes a first acid gas removal unit 31 and a first acid gas pressurizing device 32. The first acid gas removal unit 31, the first acid gas pressurizing device 32, devices similar thereto, or devices attached thereto, or the like may be collectively referred to as the CO₂ recovery device 30. The first acid gas removal unit 31 is an acid gas removal unit (AGRU) that recovers CO₂ contained in the exhaust gas from the external combustion unit 50. The first acid gas pressurizing device 32 pressurizes CO₂ recovered by the first acid gas removal unit 31. Although not particularly shown, electric power 120 or mechanical power (not shown) from the supercritical CO₂ cycle power generation unit 10 may be supplied to at least one of the first acid gas removal unit 31 or the first acid gas pressurizing device 32. The acid gas removal unit (AGRU) is a CO₂ removal unit that removes CO₂ in the exhaust gas.

In the first acid gas removal unit 31, CO₂ in the exhaust gas is absorbed using a CO₂ absorbent such as amine. Furthermore, by heating the CO₂ absorbent, CO₂ is released from the CO₂ absorbent, to regenerate the CO₂ absorbent at this time. A CO₂-containing gas separated from the CO₂ absorbent is transferred from a CO₂-containing gas transfer path 31a to the first acid gas pressurizing device 32. The CO₂-containing gas transferred in the CO₂-containing gas transfer path 31a may contain moisture or the like.

The CO₂ absorbent may be a chemical absorbent that absorbs CO₂ through an acid-base reaction of an amine or the like, or may be an adsorbent that adsorbs CO₂ through physical adsorption or chemical adsorption or the like. Although not particularly shown, the CO₂ recovery device 30 may separate and recover CO₂ from the exhaust gas using membrane separation or cryogenic separation or the like.

The treated gas in which CO₂ has been absorbed from the exhaust gas using the first acid gas removal unit 31 is emitted from a treated gas emission path 31b. When the treated gas contains nitrogen oxide (NOx), the treated gas can be released into the atmosphere as a gas in which the concentration of the nitrogen oxide is sufficiently reduced via an appropriate treatment.

In the CO₂ recovery unit 90 in the shown example, heat of the CO₂ fluid in the supercritical CO₂ cycle power generation unit 10 is supplied to the first acid gas removal unit 31 via the CO₂ heat exchanger 19. A heat transport unit 33 in the shown example includes a heating medium path 33a for causing an independent heating medium to circulate and a heating medium pump 33b for transferring the heating medium to the heating medium path 33a.

The heating medium circulating in the heating medium path 33a can receive heat supply from the CO₂ fluid of the supercritical CO₂ cycle power generation unit 10 via the CO₂ heat exchanger 19. In the CO₂ heat exchanger 19, heat of a high-temperature CO₂ fluid (600° C. to 900° C.) emitted from a supercritical CO₂ power generation turbine 12 described later is exchanged. In the first acid gas removal unit 31, the heating medium circulating in the heating medium path 33a supplies heat to the CO₂ absorbent. As a result, the heat required for regenerating the CO₂ absorbent is supplied from the supercritical CO₂ cycle power generation unit 10, whereby the use of the heating source accompanied by the release of CO₂ into the atmosphere can be suppressed.

A heat level required for regenerating the CO₂ absorbent is in a low-temperature range of 150° C. to 200° C. In the shown example, the heat is used for the relatively high-temperature CO₂ fluid after leaving the supercritical CO₂ power generation turbine 12 via the heating medium, but for example, a CO₂ fluid in a low-temperature range upstream of a CO₂ second cooler 16 described later may be extracted, and supplied to the first acid gas removal unit 31. In this case, heat in a low-temperature range having low utility value can be effectively used.

The heating medium is not particularly limited, and examples thereof include metal compounds such as a molten salt and organic compounds such as a synthetic oil. Although not particularly shown, when the heating medium is water vapor or chlorofluorocarbon or the like, the heat of the CO₂ fluid of the supercritical CO₂ cycle power generation unit 10 may be used for driving a heat engine (not shown) or the like.

The CO₂-containing gas transferred from the CO₂-containing gas transfer path 31a to the first acid gas pressurizing device 32 is pressurized by the first acid gas pressurizing device 32. The pressurized CO₂ may be a high-pressure gas or liquid CO₂. When the CO₂-containing gas contains moisture, the CO₂-containing gas may be dehydrated using a dehydrating agent such as a molecular sieve, silica gel, or zeolite. The moisture removed from the CO₂-containing gas is emitted from a drainage path 32b.

When the first acid gas pressurizing device 32 includes a dehydration unit (not shown) including a dehydrating agent, high-temperature heat of the CO₂ fluid of the supercritical CO₂ cycle power generation unit 10 may be supplied to a heat exchanger provided in the first acid gas pressurizing device 32 in order to heat and regenerate the dehydrating agent that has absorbed water. Examples of a unit for supplying heat to the dehydration unit include a unit similar to the heat transport unit 33 for supplying heat of the CO₂ fluid of the supercritical CO₂ cycle power generation unit 10 to the first acid gas removal unit 31.

Although not particularly shown, a unit that receives heat supply from the CO₂ fluid of the supercritical CO₂ cycle power generation unit 10 via the heat transport unit 33 is not limited to the first acid gas removal unit 31 and the first acid gas pressurizing device 32, and may be other units. The unit that receives the heat supply may be a unit included in the CO₂ recovery unit 90 or a unit included in the external unit 200, and may be any unit that requires a heating source. In this case, the temperature level of heat may be higher or lower than a heat level required in the first acid gas removal unit 31 and the first acid gas pressurizing device 32. That is, the heat can be supplied to various devices at a heat level that can be exchanged by the CO₂ heat exchanger 19. Specific examples thereof include a reboiler of an amine regenerator, and a reboiler of a distillation tower, and a heater of an existing FEED gas or a fuel gas when used in the external unit 200.

The exhaust gas-derived CO₂ pressurized by the first acid gas pressurizing device 32 is supplied to the supercritical CO₂ cycle power generation unit 10 via an exhaust gas-derived CO₂ transfer path 32a. As a result, the addition of the exhaust gas-derived CO₂ recovered from the exhaust gas emitted from the external combustion unit 50 to the total circulation fluid of the supercritical CO₂ cycle power generation unit 10 makes it possible to integrate the pressurizing devices to reduce the cost.

The supercritical CO₂ cycle power generation unit 10 includes a supercritical CO₂ power generation turbine 12 using a supercritical CO₂ fluid as a drive fluid. In the power generation turbine of the CO₂ cycle power generation unit, a non-supercritical CO₂ fluid may be used as the drive fluid. Furthermore, the supercritical CO₂ cycle power generation unit 10 may include a CO₂ first compression device 18 that pressurizes a CO₂ fluid after driving the supercritical CO₂ power generation turbine 12, and a supercritical CO₂ generation combustor 11 that combusts fuel using pressurized oxygen (O₂) and a light hydrocarbon containing methane as a main component.

In the supercritical CO₂ generation combustor 11, light hydrocarbon fuel containing methane as a main component is combusted using high-pressure oxygen of 200 to 400 bar in a state where the CO₂ fluid pressurized by the CO₂ first compression device 18 is mixed. The use of the supercritical CO₂ cycle power generation unit 10 makes it possible to supply energies such as electric power, heat, and mechanical power required for the CO₂ recovery unit 90 such as the air separation device 20, the first acid gas removal unit 31, the first acid gas pressurizing device 32, and the fuel gas supply unit 60.

When the temperature of CO₂ heated by the CO₂ heat exchanger 19 after leaving the CO₂ first compression device 18 is insufficient, it is necessary to further raise the temperature of CO₂. Therefore, oxygen is supplied from the air separation device 20 to the supercritical CO₂ generation combustor 11 via the oxygen path 22, to raise the temperature of CO₂ as fuel is combusted. At this time, the combustion gas emitted from the supercritical CO₂ generation combustor 11 has a high temperature of 900° C. to 1300° C. The air separation device 20 includes an oxygen pressurizing device (not shown) that pressurizes oxygen separated from air. Furthermore, as in a fourth embodiment described later, a part of the pressurized oxygen may be supplied to the combustion furnace 51. The oxygen supplied via the oxygen path 22 may have a high concentration of, for example, about 99% or more. The supply of the high-concentration oxygen makes it possible to prevent deterioration in the performance of the burner due to nitrogen oxide (NOx) caused by nitrogen as an impurity.

The air separation device 20 separates oxygen (O₂) and nitrogen (N₂) from air acquired via the air path 21. The oxygen separated from the air is compressed to a high pressure, and supplied to the supercritical CO₂ generation combustor 11 via the oxygen path 22. The nitrogen separated from the air is recovered via the nitrogen path 23. The recovered nitrogen can also be used as nitrogen gas or liquefied nitrogen or the like. The air separation device 20 may be included in the CO₂ recovery system 101, or may be included in the external unit 200.

The method of the air separation device 20 is not particularly limited, and examples thereof include temperature swing adsorption (TSA), pressure swing adsorption (PSA), pressure temperature swing adsorption (PTSA), and a cryogenic separation method. In the air separation device 20, an adsorbent may be used to selectively separate gas components. The adsorbent is not particularly limited, and examples thereof include activated carbon, a molecular sieve, and zeolite.

In the supercritical CO₂ generation combustor 11, a fuel gas containing a light hydrocarbon is used as fuel. The fuel gas is not particularly limited, and preferably contains methane (C1) as a main component, and light hydrocarbon gases such as ethane (C2), propane (C3), and butane (C4). The light hydrocarbon gas can be obtained from natural gases such as liquefied natural gas (LNG), methanation, and methane fermentation and the like. The fuel gas is supplied from the fuel gas supply unit 60 to the supercritical CO₂ generation combustor 11 via the fuel gas supply path 61. Although not particularly shown, a fuel gas pressurizing device may be used to pressurize the fuel gas before being supplied to the supercritical CO₂ generation combustor 11. Electric power or mechanical power for driving the fuel gas pressurizing device may be supplied from the supercritical CO₂ cycle power generation unit 10.

The combustion gas generated by the supercritical CO₂ generation combustor 11 has a high temperature and a high pressure due to combustion heat. The combustion gas is supplied as the supercritical CO₂ fluid to the supercritical CO₂ power generation turbine 12 via the combustion gas path 11a. The supercritical CO₂ fluid becomes a drive fluid of the supercritical CO₂ power generation turbine 12, and the generator 12a is driven to generate power.

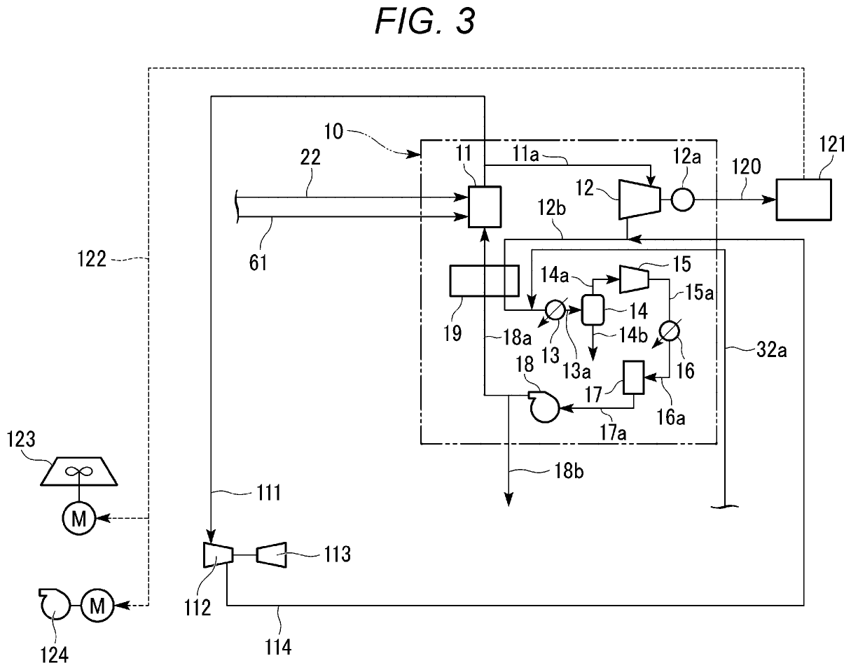

The electric power 120 obtained by the generator 12a can be supplied to the CO₂ recovery unit 90 and the external unit 200 and the like to be used. The application of the electric power 120 is not particularly limited, and examples thereof include electric power supply to a power source such as an electric motor, a heating source such as a heater, a light source such as a lighting device, a control device, a communication device, a cooling device, and an air conditioner and the like. For example, as shown in FIG. 3, the electric power 120 may be transmitted from an electric chamber 121 via a power transmission line 122, and used for driving motors for a turning device 123 and a blower 124 and the like. The electric power required in the CO₂ recovery unit 90 may be supplied only from the supercritical CO₂ cycle power generation unit 10. Possibly, the CO₂ recovery unit 90 may use external system electric power derived from renewable energy or fossil fuel.

The CO₂ fluid after driving the supercritical CO₂ power generation turbine 12 may be subjected to heat exchange with the heating medium of the heat transport unit 33 or the normal-temperature CO₂ fluid before being supplied to the supercritical CO₂ generation combustor 11 in the CO₂ heat exchanger 19 on the way through a first circulation path 12b, to be lowered in temperature, and then cooled by the CO: first cooler 13. By cooling, moisture in the CO₂ fluid is condensed to form a gas-liquid mixed fluid. The gas-liquid mixed fluid is transferred to a CO₂ gas-liquid separator 14 via a second circulation path 13a, and moisture is separated from a CO₂ gas fluid. The moisture separated from the CO₂ fluid by the CO₂ gas-liquid separator 14 is emitted from a drainage path 14b.

The CO₂ fluid from which the moisture has been separated by the CO₂ gas-liquid separator 14 is transferred from the CO₂ gas-liquid separator 14 to a CO₂ second compression device 15 via a third circulation path 14a, and is recompressed. In the CO₂ second compression device 15, the CO₂ fluid may be pressurized from a low-pressure gas to an intermediate-pressure gas of about 20 bar to 80 bar. The CO₂ fluid compressed to the intermediate-pressure level is transferred to the CO₂ second cooler 16 via a fourth circulation path 15a, and is completely liquefied. The liquid CO₂ is stored in a liquefied CO₂ storage container 17 such as a drum via a fifth circulation path 16a.

The liquid CO₂ in the liquefied CO₂ storage container 17 is transferred to a CO₂ first compression device 18 via a sixth circulation path 17a. The CO₂ first compression device 18 is, for example, a pressurizing pump. The liquid CO₂ is pressurized, and heated via the CO₂ heat exchanger 19 to become supercritical CO₂. The supercritical CO₂ is supplied to the supercritical CO₂ generation combustor 11, and directly heated by supercritical high-temperature CO₂ generated by combustion to become a drive fluid of the supercritical CO₂ power generation turbine 12. In the shown example, the CO₂ fluid supplied from the supercritical CO₂ generation combustor 11 to the supercritical CO₂ power generation turbine 12 via the combustion gas path 11a circulates in the first circulation path 12b, the second circulation path 13a, the third circulation path 14a, the fourth circulation path 15a, the fifth circulation path 16a, the sixth circulation path 17a, and the seventh circulation path 18a. In the following description, the high-temperature CO₂ fluid flowing through the first circulation path 12b is referred to as “high-temperature CO₂ fluid 12b”, and the normal-temperature CO₂ fluid flowing through the seventh circulation path 18a is referred to as “normal-temperature CO₂ fluid 18a”. The heating medium flowing through the heating medium path 33a may be referred to as a “heating medium 33a”.

The normal-temperature CO₂ fluid 18a supplied to the supercritical CO₂ generation combustor 11 performs heat exchange with the high-temperature CO₂ fluid 12b emitted from the supercritical CO₂ power generation turbine 12 via the CO₂ heat exchanger 19. As a result, the normal-temperature CO₂ fluid 18a can be supplied to the supercritical CO₂ generation combustor 11 in a state where the temperature of the CO₂ fluid 18a is increased. The CO₂ heat exchanger 19 has a first heat exchange function for supplying heat from the high-temperature CO₂ fluid 12b to the normal-temperature CO₂ fluid 18a and a second heat exchange function for supplying heat from the high-temperature CO₂ fluid 12b to the heating medium 33a of the heat transport unit 33. The first heat exchange function and the second heat exchange function may be achieved by one integrated CO₂ heat exchanger 19 as shown in FIG. 2. The high-temperature CO₂ fluid 12b may be branched on the first circulation path 12b so that the first heat exchange function and the second heat exchange function are achieved by different heat exchangers. Specifically, a heat exchanger in which the high-temperature CO₂ fluid 12b and the normal-temperature CO₂ fluid 18a exchange heat with each other and a heat exchanger in which the branched high-temperature CO₂ fluid 12b and the heating medium 33a exchange heat with each other may be different from each other.

The kinetic energy of the supercritical circulating CO₂ fluid circulating in the supercritical CO₂ cycle power generation unit 10 may be used as mechanical power. As shown in FIG. 3, for example, a part of the supercritical circulating CO₂ fluid may be extracted from the downstream of the supercritical CO₂ generation combustor 11 and the upstream of the supercritical CO₂ power generation turbine 12, and supplied to a power turbine 112 provided separately from the supercritical CO₂ power generation turbine 12 via the CO₂ fluid supply path 111. Power obtained by driving the power turbine 112 with the supercritical circulating CO₂ fluid may be supplied to mechanical devices such as a compression device 113 outside the supercritical CO₂ cycle power generation unit 10. In this case, the CO₂ fluid emitted from the power turbine 112 may be returned to the downstream side of the supercritical CO₂ power generation turbine 12 via a CO₂ fluid return path 114, and circulate in the supercritical CO₂ cycle power generation unit 10.

The power turbine 112 and the compression device 113 can be installed in, for example, the air separation device 20, the first acid gas pressurizing device 32, the fuel gas supply unit 60, and the second acid gas pressurizing unit 72 and the like. Although not particularly shown, for example, an output shaft of the power turbine 112 described above may be coupled to a drive shaft used when the exhaust gas-derived CO₂ is compressed by the first acid gas pressurizing device 32, to supply mechanical power to the first acid gas pressurizing device 32. The output shaft of the power turbine 112 may be coupled to a drive shaft of a pressurizing device other than the first acid gas pressurizing device 32. As a result, the kinetic energy of the supercritical circulating CO₂ fluid can be directly supplied to the exhaust gas-derived CO₂ and a pressurizing unit outside the supercritical CO₂ cycle power generation unit 10.

As described above, when the exhaust gas-derived CO₂ pressurized by the first acid gas pressurizing device 32 is supplied to the supercritical CO₂ cycle power generation unit 10, it is preferable to feed the exhaust gas-derived CO₂ in a state suitable for a mixing operation condition with the supercritical circulating CO₂ fluid circulating in the supercritical CO₂ cycle power generation unit 10.

A position where the exhaust gas-derived CO₂ is supplied to the supercritical CO₂ cycle power generation unit 10 is not particularly limited, and when the exhaust gas-derived CO₂ is supplied between the supercritical CO₂ power generation turbine 12 and the CO₂ first compression device 18, the pressure of the circulating CO₂ fluid is relatively low, so that the load related to the pressurization of the exhaust gas-derived CO₂ can be reduced, and therefore the unit cost can be reduced. Specifically, the exhaust gas-derived CO₂ may be supplied between the supercritical CO₂ power generation turbine 12 and the CO₂ second compression device 15. In this case, the pressure of the exhaust gas-derived CO₂ pressurized by the first acid gas pressurizing device 32 may be similar to the pressure of the CO₂ fluid on the side of the supercritical CO₂ cycle power generation unit 10 before being pressurized by the CO₂ first compression device 18. Therefore, when the exhaust gas-derived CO₂ is supplied to the supercritical CO₂ cycle power generation unit 10, the pressure of the exhaust gas-derived CO₂ may be lower than the critical pressure (73.8 barA) of CO₂.

As described above, the CO₂ fluid used in the supercritical CO₂ cycle power generation unit 10 circulates in the supercritical CO₂ cycle power generation unit 10 in a supercritical state, a liquid state, or a gas state. In the meantime, in order to compensate for the energy lost in the supercritical CO₂ cycle power generation unit 10, the light hydrocarbon fuel containing methane as a main component is combusted by high-purity oxygen in the supercritical CO₂ generation combustor 11, to replenish the energy. Therefore, excessive CO₂ is generated, and needs to be emitted from the supercritical CO₂ cycle power generation unit 10.

In the shown example, a CO₂ emission path 18b is branched from between the CO₂ first compression device 18 and the CO₂ heat exchanger 19. In this case, since a part of the CO₂ fluid having a relatively low temperature and low utility value as a temperature is emitted to the outside, a loss of thermal energy can be suppressed. Even when the CO₂ reception unit 40 requires high-pressure CO₂ as in the CO₂ capture and storage (CCS), it is possible to apply a required pressure to the emitted CO₂ fluid. Since the CO₂ fluid before being mixed with oxygen and fuel in the supercritical CO₂ generation combustor 11 contains high-purity CO₂, the CO₂ fluid is suitable as a receiving condition for the CO₂ reception unit 40.

The CO₂ reception unit 40 is not limited to the CCS as long as it is a unit that can use surplus CO₂ without releasing the surplus CO₂ into the atmosphere. Examples of the CO₂ reception unit 40 include an enhanced oil recovery unit (EOR) that injects CO₂ into an oil field to enhance oil production, a urea synthesis unit that reacts CO₂ with ammonia (NH₃) to synthesize urea, a carbonate synthesis unit that reacts CO₂ with a metal compound such as calcium hydroxide or magnesium hydroxide to synthesize a carbonate, a methane synthesis (methanation) unit that reacts CO₂ with hydrogen to synthesizes methane, and a photosynthesis promotion unit that uses CO₂ for photosynthesis of plants. The CO₂ reception unit 40 may be a transport ship or a tank truck or the like that transports liquefied CO₂. The CO₂ reception unit 40 may be included in the CO₂ recovery system 101, or may be included in the external unit 200. The CO₂ recovery system 101 may use two or more types of or two or more CO₂ reception units 40 described above.

The CO₂ emission path 18b may not be a dedicated unit that emits a surplus CO₂ fluid in the supercritical CO₂ cycle power generation unit 10, and may be shared with other CO₂ emission units. For example, when the external unit 200 includes the second acid gas removal unit 71, a CO₂ emission path 72a for emitting the existing AGRU-derived CO₂ recovered by the second acid gas removal unit 71 to the CO₂ reception unit 40 may be merged with the CO₂ emission path 18b.

Unlike the first acid gas removal unit 31, the second acid gas removal unit 71 does not include the heat transport unit 33 that supplies the heat of the CO₂ fluid of the supercritical CO₂ cycle power generation unit 10. The existing AGRU-derived CO₂ recovered by the second acid gas removal unit 71 is transferred to a new second acid gas pressurizing unit 72 via a CO₂ transfer path 71a, and is emitted to the CO₂ emission path 72a via compression, dehydration, and liquefaction and the like. The second acid gas pressurizing unit 72 emits impurities such as moisture separated from the existing AGRU-derived CO₂ from an impurity emission path 72b. The second acid gas pressurizing unit 72 may remove components that are not preferable for the downstream CO₂ reception unit 40, for example, hydrogen sulfide (H₂S) and the like from an existing AGRU-derived CO₂-containing gas as necessary. Specifically, the second acid gas pressurizing unit 72 may include at least one of a dehydration device and a liquefaction device. The second acid gas pressurizing unit 72 may be included in the CO₂ recovery system 101, or may be included in the external unit 200.

The exhaust gas-derived CO₂ pressurized by the first acid gas pressurizing device 32 may be emitted to the CO₂ reception unit 40 via the exhaust gas-derived CO₂ transfer path 32a and a CO₂ emission path 41. In this case, the first acid gas pressurizing device 32 may pressurize the exhaust gas-derived CO₂ to a pressure suitable for reception in the CO₂ reception unit 40. The CO₂ emission path 41 may join the CO₂ emission path 18b of the supercritical CO₂ cycle power generation unit 10 instead of directly emitting CO₂ to the CO₂ reception unit 40. In short, the surplus CO₂ fluid in the supercritical CO₂ cycle power generation unit 10 and CO₂ recovered by the first and second acid gas removal units may be emitted to the CO₂ reception unit 40, and recovered without being released into the atmosphere.

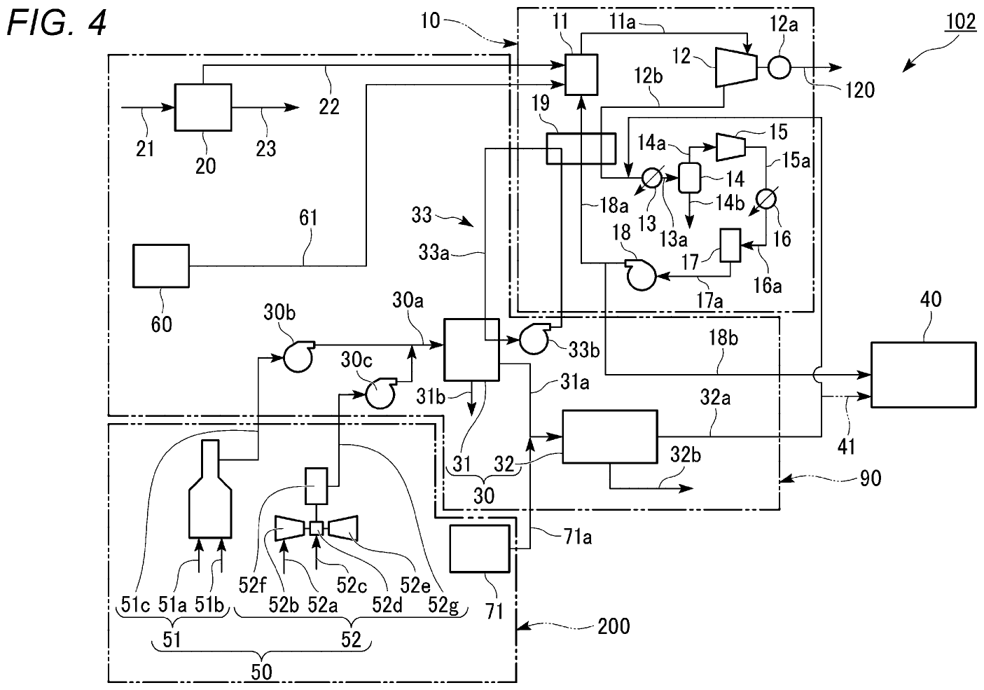

Next, a CO₂ recovery system 102 according to a second embodiment will be described with reference to FIG. 4. Similarly to the CO₂ recovery system 101 of the first embodiment, the CO₂ recovery system 102 of the second embodiment includes a supercritical CO₂ cycle power generation unit 10 and a CO₂ recovery unit 90 that recovers an exhaust gas of an external combustion unit 50. Elements common to the first embodiment in the second embodiment are denoted by the same reference numerals, and the redundant description thereof may be omitted.

In the case of the second embodiment, existing AGRU-derived CO₂ recovered by a second acid gas removal unit 71 is supplied to the supercritical CO₂ cycle power generation unit 10. In order to transfer the existing AGRU-derived CO₂ recovered by the second acid gas removal unit 71, a CO₂ transfer path 71a is connected to the inlet side of a first acid gas pressurizing device 32. The first acid gas pressurizing device 32 pressurizes the existing AGRU-derived CO₂ recovered from the second acid gas removal unit 71 as an external unit 200 and exhaust gas-derived CO₂ recovered from an exhaust gas by a first acid gas removal unit 31 together.

The existing AGRU-derived CO₂ and the exhaust gas-derived CO₂ that are pressurized by the first acid gas pressurizing device 32 are supplied to the supercritical CO₂ cycle power generation unit 10 via an exhaust-derived CO₂ transfer path 32a. A position where the exhaust gas-derived CO₂ containing the existing AGRU-derived CO₂ is supplied to the supercritical CO₂ cycle power generation unit 10 is not particularly limited as in the first embodiment, and may be supplied between a supercritical CO₂ power generation turbine 12 and a CO₂ first compression device 18.

In the case of the second embodiment, when the external unit 200 includes the external combustion unit 50, and the second acid gas removal unit 71 as an external acid gas removal unit, the first acid gas pressurizing device 32 can be shared by the first acid gas removal unit 31 and the second acid gas removal unit 71, so that the cost of the unit required for pressurizing CO₂ can be reduced.

Although not particularly shown, even in CO₂ recovery systems 103 and 104 according to a third or fourth embodiment described later, similarly to the second embodiment, the first acid gas pressurizing device 32 can also pressurize the exhaust gas-derived CO₂ recovered by the first acid gas removal unit 31 and the existing AGRU-derived CO₂ recovered from the second acid gas removal unit 71 together. In this case, a second acid gas pressurizing unit 72 can be omitted.

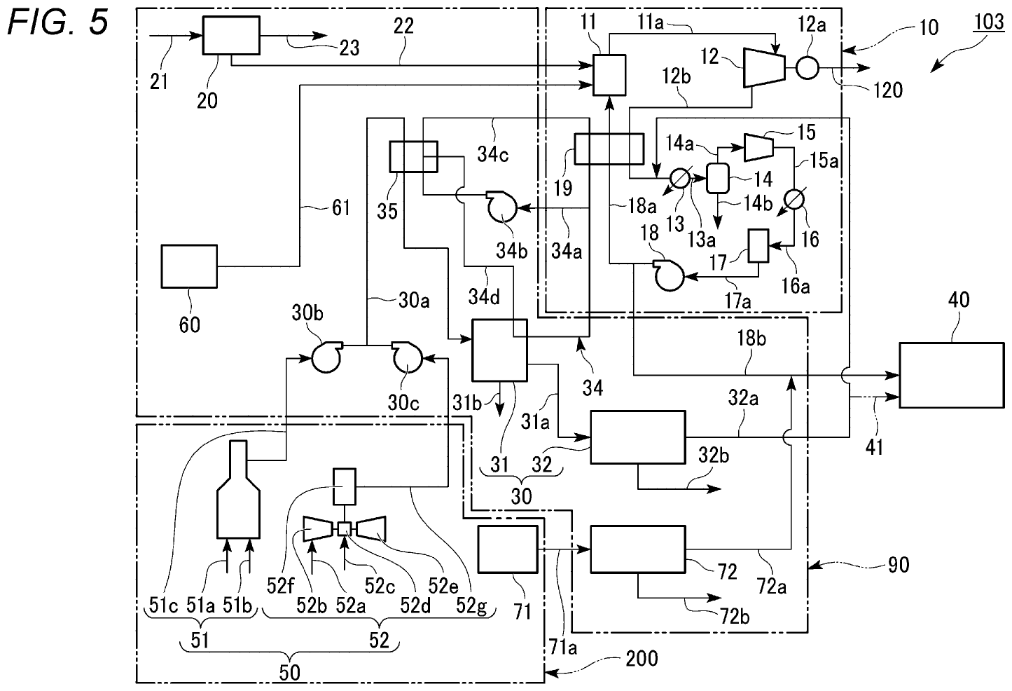

Next, a CO₂ recovery system 103 according to a third embodiment will be described with reference to FIG. 5. Similarly to the CO₂ recovery system 101 of the first embodiment, the CO₂ recovery system 103 of the third embodiment includes a supercritical CO₂ cycle power generation unit 10 and a CO₂ recovery unit 90 that recovers an exhaust gas of an external combustion unit 50. Elements common to the first embodiment in the third embodiment are denoted by the same reference numerals, and the redundant description thereof may be omitted. An exhaust gas flowing through an exhaust gas recovery path 30a may be referred to as an “exhaust gas fluid 30a”.

In the third embodiment, when an exhaust gas of an external combustion unit 50 (specifically, a combustion furnace 51 and a combustor 52d of a gas turbine device 52) recovered via the exhaust gas recovery path 30a using exhaust gas blowers 30b and 30c has a high temperature of 150° C. or higher, the heat of the exhaust gas is supplied to a normal-temperature CO: fluid 18a of the supercritical CO: cycle power generation unit 10 via a heat transport unit 34 by an exhaust gas heat exchanger 35. When the temperature of the normal-temperature CO₂ fluid 18a of the supercritical CO: cycle power generation unit 10 is lower than the temperature of the exhaust gas fluid 30a of the external combustion unit 50, heat can be supplied from the exhaust gas side to the CO-fluid side. As a result, a part of energy required for heating a drive fluid of the supercritical CO: cycle power generation unit 10 can be replenished with the heat of the exhaust gas from the external combustion unit 50, to save the fuel of a supercritical CO₂ generation combustor 11.

The heat transport unit 34 used in the CO: recovery system 103 of the third embodiment includes a heating medium path 34a in which an independent heating medium is transferred, a heating medium pump 34b that transfers the heating medium in the heating medium path 34a, a heating medium path 34c that is separated from the heating medium path 34a downstream of the heating medium pump 34b and passes through a CO: heat exchanger 19 of the supercritical CO: cycle power generation unit 10, a heating medium path 34d that is separated from the heating medium path 34a and passes through a first acid gas removal unit 31 of the CO: recovery unit 90, and an exhaust gas heat exchanger 35 that performs heat exchange between the high-temperature exhaust gas from the external combustion unit 50 and the heating medium.

According to the heat transport unit 34 of the shown example, the heating medium circulating in the heating medium path 34a and the heating medium path 34c can receive heat supply from the high-temperature exhaust gas from the external combustion unit 50 in the exhaust gas heat exchanger 35. Furthermore, the heating medium of the heat transport unit 34 can exchange heat with the normal-temperature CO₂ fluid of the supercritical CO₂ cycle power generation unit 10 in the CO₂ heat exchanger 19. As a result, heat can be supplied from the high-temperature exhaust gas from the external combustion unit 50 to the normal-temperature CO₂ fluid. The heating medium of the heat transport unit 34 can supply heat for regenerating a CO₂ absorbent in the first acid gas removal unit 31. As a result, the heat required for regenerating the CO₂ absorbent is supplied from the high-temperature exhaust gas from the external combustion unit 50, whereby the use of the heating source accompanied by the release of CO₂ into the atmosphere can be suppressed.

Although not particularly shown, the unit that receives heat supply from the heating medium in the heating medium path 34d is not limited to the first acid gas removal unit 31, and may be various units of the CO₂ recovery unit 90. As a result, it is possible to supply a required level of heat from the high-temperature exhaust gas from the external combustion unit 50 to devices and units that require heat in the CO₂ recovery unit 90.

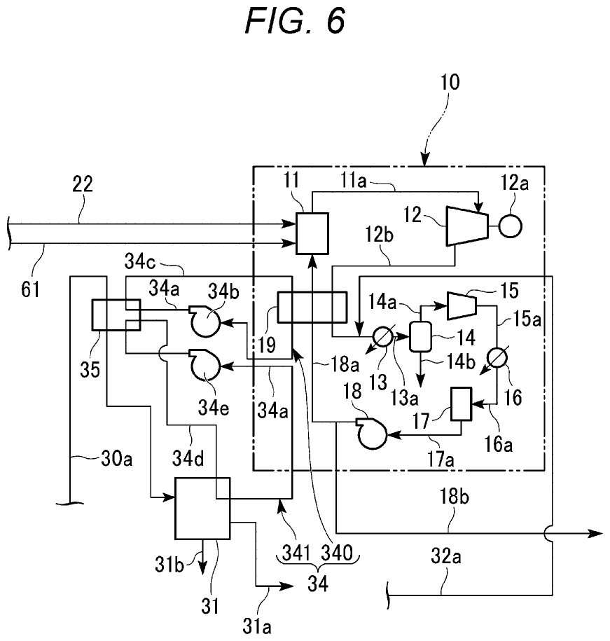

As shown in FIG. 6, heat supply from the high-temperature exhaust gas from the external combustion unit 50 to the CO₂ fluid and heat supply from the high-temperature exhaust gas to the first acid gas removal unit 31 may be performed by the separate heat transport units 34. Specifically, a circulation path 340 for supplying heat to the CO₂ fluid and a circulation path 341 for supplying heat to the first acid gas removal unit 31 may be independent from each other. The heating medium pumps 34b and 34e are respectively provided in the circulation paths 340 and 341.

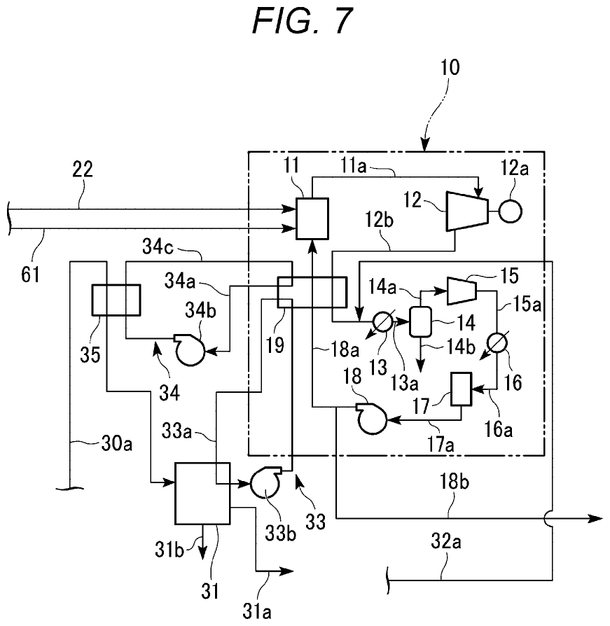

As shown in FIG. 7, the heat transport unit 33 of the first embodiment may be used in combination with the heat transport unit 34 of the third embodiment. In this case, heat may be supplied to the first acid gas removal unit 31 by the heat transport unit 33, and heat may be supplied to the CO₂ fluid by the heat transport unit 34.

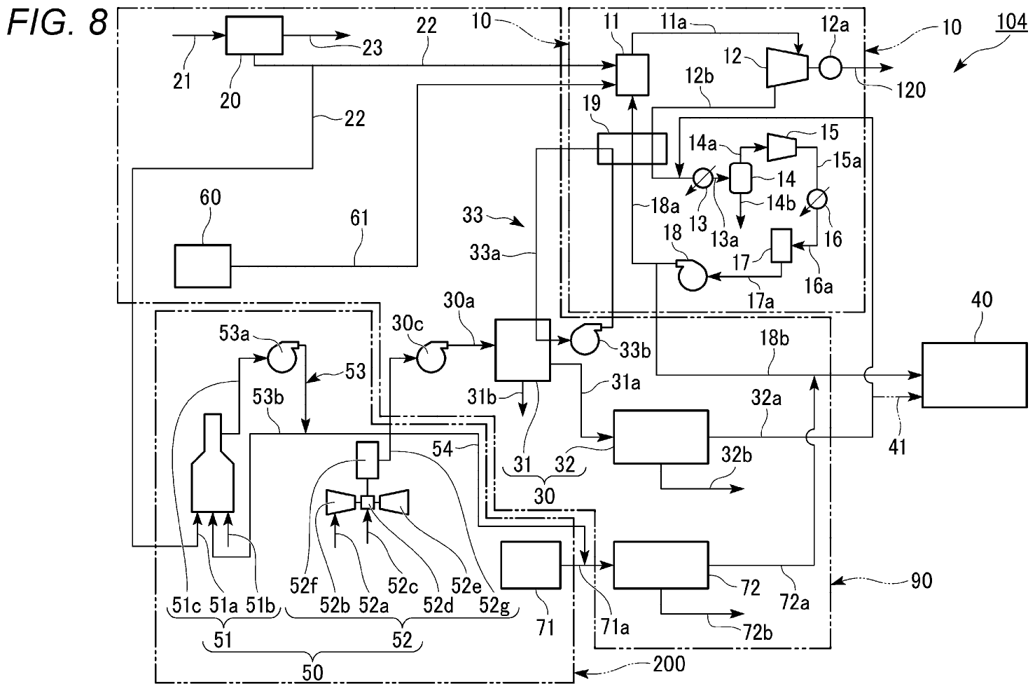

Next, a CO₂ recovery system 104 according to a fourth embodiment will be described with reference to FIG. 8. Similarly to the CO₂ recovery system 101 of the first embodiment, the CO₂ recovery system 104 of the fourth embodiment includes a supercritical CO₂ cycle power generation unit 10 and a CO₂ recovery unit 90 that recovers exhaust gas of an external combustion unit 50. Elements common to the first embodiment in the fourth embodiment are denoted by the same reference numerals, and the redundant description thereof may be omitted.

In the CO₂ recovery system 104 of the fourth embodiment, a part of oxygen separated by an air separation device 20 is branched from an oxygen path 22 toward a supercritical CO₂ generation combustor 11 of the supercritical CO₂ cycle power generation unit 10, and supplied to a combustion furnace 51, to combust fuel supplied from a fuel path 51b.

The exhaust gas of the combustion furnace 51 is emitted in a high-temperature state from an exhaust gas path 51c since oxygen combustion causes a high CO₂ concentration and an extremely small amount of nitrogen oxide (NOx). An exhaust gas circulation cycle 53 may be formed by a circulation path 53b that returns a part of a combustion gas from an exhaust gas path 51c to the combustion furnace 51 via a circulation blower 53a. By returning the exhaust gas to the combustion furnace 51, the inside of the combustion furnace 51 having a high temperature due to oxygen combustion can be cooled.

Although not particularly shown, the exhaust gas heat exchanger 35 of the heat transport unit 34 of the third embodiment may be provided in an exhaust gas circulation cycle 53 of the fourth embodiment. As a result, a part of heat of the high-temperature exhaust gas can be supplied to the supercritical CO₂ cycle power generation unit 10 or the CO₂ recovery unit 90.

If oxygen and fuel are combusted while the exhaust gas is caused to circulate in the circulation path 53b including the combustion furnace 51, the amount of CO₂ in the exhaust gas increases. The excessive CO₂ may be transferred to a second acid gas pressurizing unit 72 via a CO₂ recovery path 54 branched from the exhaust gas circulation cycle 53, and emitted to a CO₂ reception unit 40 via a CO₂ emission path 72a.

Although not particularly shown, the high-concentration CO₂ recovered from the CO₂ recovery path 54 may be transferred to a first acid gas pressurizing device 32, and supplied to the supercritical CO₂ cycle power generation unit 10. When CO₂ recovered from the CO₂ recovery path 54 contains nitrogen oxide (NOx) or the like, CO₂ may be transferred to a first acid gas removal unit 31. When CO₂ recovered from the CO₂ recovery path 54 does not contain impurities other than oxygen or moisture, CO₂ may be transferred to the first acid gas pressurizing device 32 without passing through a first acid gas removal unit 31.

The present invention is described above on the basis of preferred embodiments, but the present invention is not limited to the above embodiments. Various modifications are possible without departing from the spirit of the present invention. Examples of the modifications replacement, omission, and other changes of elements in each embodiment. The elements used in two or more embodiments can be appropriately combined.

While electric power supply tends to rely on unstable renewable energy in order to suppress the emission of CO₂, the present invention includes the CO₂ cycle power generation unit using the CO₂ fluid having supercritical high energy as the drive fluid, so that required electric power can be constantly supplied into the power generation device and external units related thereto.

Furthermore, CO₂ emitted from the external combustion unit into the atmosphere is recovered from the newly installed acid gas removal unit, and then temporarily sent into the CO₂ cycle power generation unit, whereby an excessive amount of CO₂ can be extracted as the high-concentration CO₂ fluid. As a receiving destination of the released high-concentration CO₂ fluid, underground isolation or reuse unit (CO₂ reception unit) is prepared, whereby the emission of CO₂ into the atmosphere can be significantly suppressed.

When the exhaust gas of the external combustion device has a high temperature, the exhaust gas can also be supplied as heat to the CO₂ cycle power generation unit via the heating medium. In this way, a CO₂ recovery system capable of sharing electricity and heat as an energy form can be constructed to provide an innovative environmental protection system aiming at zero emission of a greenhouse gas (GHG) that does not depend on renewable energy.

Specifically, CO₂ emitted from the external combustion unit is directly recovered by a new acid gas removal unit, and required electric power and heat are provided from the CO₂ cycle power generation unit. CO₂ extracted from the external combustion unit is once sent to the CO₂ cycle power generation unit in an intermediate-pressure state, mixed with a general circulating CO₂ fluid. Then, only an excessive amount of the mixture is emitted in a form that is easily extracted as a high-purity high-pressure CO₂ liquid from the CO₂ cycle power generation unit.

Since the emitted CO₂ is isolated in the ground or reused, the release of CO₂ into the atmosphere can be significantly suppressed. The CO₂ recovery other than the external combustion unit can also be applied to, for example, the recovery of CO₂ emitted from the thermal decomposition of limestone or the like. By mixing CO₂ emitted from various plants and the like including an external CO₂ emission unit with the general circulating CO₂ fluid of the CO₂ cycle power generation unit, scattered related devices can be integrated. Furthermore, the excessive amount of the CO₂ fluid after the mixing treatment can also be collectively sent to the CO₂ reception unit.

### INDUSTRIAL APPLICABILITY

The present invention can be used for various industries requiring CO₂ recovery.

### REFERENCE SIGNS LIST

E energy
F fluid
10 supercritical CO₂ cycle power generation unit
11 supercritical CO₂ generation combustor
11a combustion gas path
12 supercritical CO₂ power generation turbine
12a generator
12b first circulation path or high-temperature CO₂ fluid
13 CO₂ first cooler
13a second circulation path
14 CO₂ gas-liquid separator
14a third circulation path
14b drainage path of CO₂ gas-liquid separator
15 CO₂ second compression device
15a fourth circulation path
16 CO₂ second cooler
16a fifth circulation path
17 liquefied CO₂ storage container
17a sixth circulation path
18 CO₂ first compression device
18a seventh circulation path or normal-temperature CO₂ fluid
18b CO₂ emission path
19 CO₂ heat exchanger
20 air separation device
21 air path
22 oxygen path
23 nitrogen path
30 CO₂ recovery device
30a exhaust gas recovery path or exhaust gas fluid
30b, 30c exhaust gas blower
31 first acid gas removal unit
31a CO₂-containing gas transfer path
31b treated gas emission path
32 first acid gas pressurizing device
32a exhaust gas-derived CO₂ transfer path
32b drainage path of acid gas pressurizing device
33, 34 heat transport unit
33a heating medium path or heating medium
33b, 34b, 34e heating medium pump
34a, 34c, 34d heating medium path
35 exhaust gas heat exchanger
40 CO₂ reception unit
41 CO₂ emission path
50 external combustion unit
51 combustion furnace
51a air path of combustion furnace
51b fuel path of combustion furnace
51c exhaust gas path of combustion furnace
52 gas turbine device
52a air path of gas turbine device
52b compressor of gas turbine device
52c fuel path of gas turbine device
52d combustor of gas turbine device
52e turbine
52f exhaust tube
52g exhaust gas path of gas turbine device
53 exhaust gas circulation cycle
53a circulation blower
53b circulation path of combustion furnace
54 CO₂ recovery path
60 fuel gas supply unit
61 fuel gas supply path
71 second acid gas removal unit
71a CO₂ transfer path
72 second acid gas pressurizing unit
72a CO₂ emission path
72b impurity emission path
90 CO₂ recovery unit
100, 101, 102, 103, 104 CO₂ recovery system
111 CO₂ fluid supply path
112 power turbine
113 compression device
114 CO₂ fluid return path
120 electric power
121 electric chamber
122 power transmission line
123 turning device
124 blower
200 external unit
340, 341 circulation path of heat transport unit

1. A carbon dioxide recovery method using a carbon dioxide recovery system, the carbon dioxide recovery system comprising:
a carbon dioxide cycle power generation unit including a power generation turbine using a carbon dioxide fluid as a drive fluid, a CO₂ first compression device pressurizing the carbon dioxide fluid after driving the power generation turbine, a CO₂ heat exchanger heating the carbon dioxide fluid pressurized by the CO₂ first compression device, and a combustor mixing the carbon dioxide fluid heated by the CO₂ heat exchanger, oxygen supplied from an air separation device, and a light hydrocarbon gas containing methane as a main component, to combust the light hydrocarbon gas under heating, wherein a combustion gas obtained by heating in the combustor is supplied to the power generation turbine as the drive fluid; and
a carbon dioxide recovery unit recovering carbon dioxide from a carbon dioxide-containing exhaust gas emitted by fuel combustion in an external combustion unit, wherein
a part of the carbon dioxide fluid emitted from the carbon dioxide cycle power generation unit and the carbon dioxide recovered by the carbon dioxide recovery unit are supplied to a carbon dioxide reception unit capable of receiving carbon dioxide; and
energy obtained by the carbon dioxide cycle power generation unit is supplied to the carbon dioxide recovery unit,
wherein the energy supplied from the carbon dioxide cycle power generation unit to the carbon dioxide recovery unit includes electric power obtained by the power generation turbine,
the carbon dioxide recovery unit includes a first acid gas removal unit recovering the carbon dioxide contained in the exhaust gas from the external combustion unit, and a first acid gas pressurizing unit pressurizing the carbon dioxide recovered by the first acid gas removal unit, and the electric power obtained by the power generation turbine is supplied to the first acid gas pressurizing unit, and
wherein the carbon dioxide pressurized by the first acid gas pressurizing unit is supplied between the power generation turbine and the CO₂ first compression device, and mixed with the carbon dioxide fluid.

2. (canceled)

3. The carbon dioxide recovery method according to claim 1, wherein the energy supplied from the carbon dioxide cycle power generation unit to the carbon dioxide recovery unit includes heat of the carbon dioxide fluid.

4. The carbon dioxide recovery method according to claim 1, wherein the energy supplied from the carbon dioxide cycle power generation unit to the carbon dioxide recovery unit includes mechanical power obtained from the combustion gas obtained by the combustor.

5. (canceled)

6. The carbon dioxide recovery method according to claim 3, wherein the heat of the carbon dioxide fluid is supplied to the first acid gas removal unit by heat exchange.

7. The carbon dioxide recovery method according to claim 6, wherein the energy supplied from the carbon dioxide cycle power generation unit to the carbon dioxide recovery unit includes the power obtained by the power generation turbine and the heat of the carbon dioxide fluid, and the power obtained by the power generation turbine is supplied to the first acid gas pressurizing unit.

8. The carbon dioxide recovery method according to claim 6, wherein the first acid gas removal unit performs a recovery step of causing a carbon dioxide absorbent to absorb the carbon dioxide contained in the exhaust gas from the external combustion unit to recover the carbon dioxide, and a regeneration step of heating the carbon dioxide absorbent to release the carbon dioxide, and the heat of the carbon dioxide fluid is supplied to the regeneration step by heat exchange.

9. (canceled)

10. The carbon dioxide recovery method according to claim 1, wherein
the first acid gas pressurizing unit pressurizes a carbon dioxide-containing gas recovered from the exhaust gas from the external combustion unit by the first acid gas removal unit and a carbon dioxide-containing gas recovered from a second acid gas removal unit which is an acid gas removal unit other than the first acid gas removal unit.

11. The carbon dioxide recovery method according to claim 1, wherein the heat of the exhaust gas from the external combustion unit is supplied to the carbon dioxide fluid circulating in the carbon dioxide cycle power generation unit and having a temperature lower than that of the exhaust gas by heat exchange.

12. The carbon dioxide recovery method according to claim 1, wherein the external combustion unit includes a combustion furnace, the carbon dioxide recovery system includes an air separation device separating oxygen supplied to the carbon dioxide cycle power generation unit from air, and a part of the oxygen obtained by the air separation device is supplied to the combustion furnace.

13. The carbon dioxide recovery method according to claim 1, wherein the heat of the carbon dioxide fluid is supplied from the carbon dioxide cycle power generation unit to an outside of the carbon dioxide cycle power generation unit.

14. (canceled)

15. (canceled)

16. A carbon dioxide recovery method using a carbon dioxide recovery system, the carbon dioxide recovery system comprising:
a carbon dioxide cycle power generation unit including a power generation turbine using a carbon dioxide fluid as a drive fluid, a CO₂ first compression device pressurizing the carbon dioxide fluid after driving the power generation turbine, a CO₂ heat exchanger heating the carbon dioxide fluid pressurized by the CO₂ first compression device, and a combustor mixing the carbon dioxide fluid heated by the CO₂ heat exchanger, oxygen supplied from an air separation device, and a light hydrocarbon gas containing methane as a main component, to combust the light hydrocarbon gas under heating, wherein a combustion gas obtained by heating in the combustor is supplied to the power generation turbine as the drive fluid; and
a carbon dioxide recovery unit recovering carbon dioxide from a carbon dioxide-containing exhaust gas emitted by fuel combustion in an external combustion unit, wherein
a part of the carbon dioxide fluid emitted from the carbon dioxide cycle power generation unit and the carbon dioxide recovered by the carbon dioxide recovery unit are supplied to a carbon dioxide reception unit capable of receiving carbon dioxide; and
energy obtained by the carbon dioxide cycle power generation unit is supplied to the carbon dioxide recovery unit,
wherein the energy supplied from the carbon dioxide cycle power generation unit to the carbon dioxide recovery unit includes heat of the carbon dioxide fluid,
the carbon dioxide recovery unit includes a first acid gas removal unit recovering the carbon dioxide contained in the exhaust gas from the external combustion unit, and a first acid gas pressurizing unit pressurizing the carbon dioxide recovered by the first acid gas removal unit, and the heat of the carbon dioxide fluid is supplied to the first acid gas removal unit by heat exchange, and
wherein the carbon dioxide pressurized by the first acid gas pressurizing unit is supplied between the power generation turbine and the CO₂ first compression device, and mixed with the carbon dioxide fluid.

17. A carbon dioxide recovery method using a carbon dioxide recovery system, the carbon dioxide recovery system comprising:
a carbon dioxide cycle power generation unit including a power generation turbine using a carbon dioxide fluid as a drive fluid, a CO₂ first compression device pressurizing the carbon dioxide fluid after driving the power generation turbine, a CO₂ heat exchanger heating the carbon dioxide fluid pressurized by the CO₂ first compression device, and a combustor mixing the carbon dioxide fluid heated by the CO₂ heat exchanger, oxygen supplied from an air separation device, and a light hydrocarbon gas containing methane as a main component, to combust the light hydrocarbon gas under heating, wherein a combustion gas obtained by heating in the combustor is supplied to the power generation turbine as the drive fluid; and
a carbon dioxide recovery unit recovering carbon dioxide from a carbon dioxide-containing exhaust gas emitted by fuel combustion in an external combustion unit, wherein
a part of the carbon dioxide fluid emitted from the carbon dioxide cycle power generation unit and the carbon dioxide recovered by the carbon dioxide recovery unit are supplied to a carbon dioxide reception unit capable of receiving carbon dioxide; and
energy obtained by the carbon dioxide cycle power generation unit is supplied to the carbon dioxide recovery unit,
wherein the heat of the exhaust gas from the external combustion unit is supplied to the carbon dioxide fluid circulating in the carbon dioxide cycle power generation unit and having a temperature lower than that of the exhaust gas by heat exchange.
